(19) United States
(12) Patent Application Publication
(10) Pub. No.: US 2025/0128609 A1
(43) Pub. Date: Apr. 24, 2025

(54) METHOD OF OPERATING A MAIN DRIVE OF AN ELECTRIC VEHICLE

(71) Applicant: Brose Fahrzeugteile SE & Co. Kommanditgesellschaft, Wuerzburg, Wuerzburg (DE)

(72) Inventors: Parth AKOOL, Pune (IN); Christian BIENICK, Gerbrunn (DE); Sumit GAVASANE, Pune (IN)

(73) Assignee: Brose Fahrzeugteile SE & Co. Kommanditgesellschaft, Wuerzburg, Wuerzburg (DE)

(21) Appl. No.: 19/007,811

(22) Filed: Jan. 2, 2025

Related U.S. Application Data
(63) Continuation of application No. PCT/EP2023/066469, filed on Jun. 19, 2023.

(30) Foreign Application Priority Data
Jul. 1, 2022 (IN) 202241038050

(51) Int. Cl. B60L 15/20

(52) U.S. Cl. CPC B60L 15/20; B60L 2200/12; B60L 2240/14

(57) ABSTRACT

A method for operating a main drive of an electric vehicle, in which a first acceleration value is determined on the basis of a setting of an operating element. Based on a deviation of a current acceleration from a predetermined maximum acceleration, a second acceleration value is determined, and the minimum of the first acceleration value and the second acceleration value is selected as a control value. An Energization of the main drive is adjusted in accordance with the control value. Furthermore, the invention provides a main drive of an electric vehicle and a computer program product.

This nonprovisional application is a continuation of International Application No. PCT/EP2023/066469, which was filed on Jun. 19, 2023, and which claims priority to Indian Patent Application No. 202241038050, which was filed in India on Jul. 1, 2022, and which are both herein incorporated by reference.

### BACKGROUND OF THE INVENTION

### Field of the Invention

The invention relates to a method for operating a main drive of an electric vehicle. Furthermore, the invention relates to a main drive of an electric vehicle and to a computer program product.

Description of the Background Art

Motor vehicles have a main drive for propulsion, which acts on one or more wheels of the motor vehicle. If the main drive does not comprise an internal combustion engine but only one or more electric motors, these are also referred to as electric vehicles. Usually, the electric vehicle comprises a control element, the setting of which is used to set a current supply to the electric motor, i.e., the main drive. The control element here is, for example, a (gas) handle or a foot pedal. In the case of a comparatively extensive adjustment of the control element, the main drive is usually set in such a way that it delivers an increased torque so that the electric vehicle accelerates.

To adapt to current conditions, a current state of the driver/user of the electric vehicle or to increase the driving experience, several driving profiles are usually provided, on the basis of which a basic setting of the electric vehicle is made. Thus, it is possible to move the electric vehicle and also the main drive, for example, to a greater extent sporty or to a greater extent comfortable. It is also possible, for example, to select a separate driving profile for an electric vehicle intended for rental. In addition, it is possible, for example, to obtain a different classification for vehicle insurance on the basis of a specific driving profile setting.

The maximum achievable speed of the electric vehicle usually differs for the different driving profiles, which can help prevent accidents. In addition, the maximum torque provided by the main drive is set depending on the selected driving profile, resulting in reduced acceleration. However, as soon as the electric vehicle is moved along a comparatively steep road, it is possible that a current speed cannot be maintained or even the elevation cannot be climbed due to the reduced maximum torque, although this would be technically possible by means of the main drive. Due to the drastically reduced speed, it is also possible that a following road user will hit the electric vehicle.

### SUMMARY OF THE INVENTION

It is therefore an object of the invention to provide a method for operating a main drive of an electric vehicle and a main drive of an electric vehicle as well as a computer program product, whereby advantageously a comfort and/or a driving experience are improved, and whereby expediently a safety is increased.

The main drive is a component of an electric vehicle. In other words, the main drive is suitable, in particular provided and arranged (set up), to be a component of the electric vehicle in the assembled state, with the electric vehicle being moved directly by means of the main drive. The electric vehicle is preferably land-bound. The main drive is in particular suitable, provided and arranged to be supplied with current by an on-board power supply of the electric vehicle, which carries, for example, a DC voltage of 12 V, 24 V or 48 V or more than 100 V. The electric vehicle is, for example, a passenger car, a truck or a bus. Preferably, the electric vehicle is two-wheeled, for example an e-bike or, particularly preferably, a motor scooter and thus a so-called e-scooter. The main drive comprises an electric motor. In particular, a speed of the electric vehicle results as a function of an energization of the electric motor. The electric motor is preferably a brushless DC motor (BLDC) and expediently a synchronous motor.

According to the method, a first acceleration value can be determined on the basis of a setting of an operating element. The control element is suitable, in particular intended and arranged to be operated by a user of the electric vehicle. The operating element is in particular a handle, which is preferably designed to be rotatable. Alternatively, the operating element is, for example, a foot pedal, in particular a so-called accelerator pedal. The control element preferably has a sensor by means of which the current setting of the control element is detected. By the method, the sensor is read out in particular, which is, for example, a component of the main drive itself. Alternatively, the readout is performed via an interface of the main drive that is signal-coupled to the sensor.

The first acceleration value can correspond, for example, to an acceleration desired by the user, for example. It is possible, for example, that the current speed of the electric vehicle is to be maintained or that the electric vehicle is to be accelerated, i.e., the speed of the electric vehicle is to be changed. In particular, the amount by which the speed of the electric vehicle is to be changed can also be indicated by the first acceleration value, if any. In summary, different first acceleration values are determined for different settings of the control element, with the respective first acceleration value in each case being functionally related to the acceleration of the electric vehicle desired by the user, in particular in a linear relationship.

In addition, a second acceleration value can be determined on the basis of a deviation of a current acceleration from a specified maximum acceleration. The current acceleration is the actual acceleration of the electric vehicle, i.e., the acceleration that is currently being realized by the electric vehicle. In particular, the actual value of the current acceleration is determined for this purpose, or at least a value corresponding thereto. The maximum acceleration is predetermined and in particular static, at least for a certain period of time. The maximum acceleration is, for example, also a value of the acceleration or at least a value corresponding thereto.

The maximum acceleration can be specified, for example, by the user or another person, for example of a workshop. The maximum acceleration is, for example, independent of the (mechanical and/or electrical) design of the main drive. In particular, the maximum acceleration is lower than an acceleration that is maximally possible due to the mechanical/electrical design of the main drive. The second acceleration value is in particular the difference between the maximum acceleration and the current acceleration. Here, in particular, the current acceleration is subtracted from the maximum acceleration, and this value is the second acceleration value. Alternatively, further processing of the difference is performed to obtain the second acceleration value. At least, however, the second acceleration value corresponds to a deviation between the current acceleration and the maximum acceleration.

In a further step, the minimum of the first acceleration value and the second acceleration value is selected as a control value. In other words, it is checked whether the first acceleration value or the second acceleration value is smaller, and the smaller value in each case is used as the control value.

In a subsequent step, the energization, e.g., the current flow, of the main drive is set according to the control value. For example, a current flow of the main drive, particularly of the electric motor, is adapted and thus changed, or the energization isn't altered, in particular if the control value is zero. At least, however, the main drive is operated according to the control value. In particular, to adjust the energization, an already existing energization, e.g., the already existing current flow, is increased or decreased by the control value. In other words, the existing energization is increased or decreased by the control value or at least to a value corresponding to the control value, so that a change of the speed of the electric vehicle results, if desired by the user.

The method thus ensures that the electric vehicle is never operated at an acceleration greater than the specified maximum acceleration. However, there is no electric current limitation or limitation of a maximum force/torque to be applied by means of the main drive. Thus, if the electric vehicle is moved along an incline or with a comparatively high payload, the same acceleration and thus essentially the same driving behavior is realized according to the method, which also prevails on a level road and with a low payload. Thus, in the case of the uphill gradient/high payload, an energization is selected by means of which the first acceleration value or the maximum acceleration is achieved. This type of energization would lead to the maximum acceleration being exceeded, for example, in the case of a comparatively low gradient or low payload. In this case, this kind of energization is prevented. Since the energization/power supply to the main drive is thus essentially independent of the current load of the electric vehicle, it is possible for the user to always operate the electric vehicle according to the desired acceleration or maximum acceleration.

In summary, according to the method, it is in particular not the electric current that is limited, but the acceleration. Due to the essentially always the same acceleration, a comfort and a driving experience for the user is increased. Also, in case of a comparatively low maximum acceleration and a comparatively steep incline or comparatively high payload it is essentially always possible to maintain or, if necessary, increase the speed of the electric vehicle, regardless of the type of road surface. Thus, there is no unexpected or undesired reduction in speed to which, for example, further road users are not adjusted. Consequently, a rear-end collision of the further road users is prevented and a safety is increased.

Preferably, the main drive comprises a control unit, by means of which the method is at least partially carried out. Suitably, the main drive comprises an inverter by means of which the electric current is supplied to the electric motor, the inverter in particular being set in accordance with the control value by means of the control unit.

For example, the respective acceleration value, i.e., the first acceleration value and the second acceleration value, is in each case the value of an acceleration (i.e., m/s\hat{ } 2). Particularly preferably, however, there is a functional relationship between the respective acceleration values and the value of the acceleration. For example, the value of a power is used as the respective acceleration value. Particularly preferably, the value of a torque is used as the respective acceleration value. Thus, the control value is also the value of a torque. Thus, it is possible, for example, to display the first acceleration value, the second acceleration value and/or the control value to the user, whereby the user can interpret them. In this way, it is also easier to determine an energization, e.g., electric current, by means of which the electric motor is to be operated. For this in particular a motor model is used, which corresponds to the used electric motor. This reduces the effort required to set the energization.

For example, the maximum acceleration is specified by the manufacturer of the main drive. This makes it possible, for example, to always use the same main drive mechanically for different electric vehicles, but still realize different characteristics. Particularly preferably, however, the specified maximum acceleration is read out from a selected driving profile. In this case, several driving profiles are expediently available for selection, with the maximum acceleration differing, for example, between some or all of the driving profiles. Alternatively or in combination with this, different maximum speeds of the electric vehicle are stored for different driving profiles, for example.

The driving profiles are stored in a memory, for example, which is, for example, a component of the main drive. Alternatively, the memory is part of a separate component of the electric vehicle, such as an on-board computer. The maximum acceleration is thus read out from this in accordance with the method. For example, the driving profiles are predetermined on the part of the manufacturer of the electric vehicle and/or the main drive. Alternatively, these or at least some of them can be modified by the user.

For example, it is possible for the user to select the driving profile so that the user can select the driving profile according to a current situation. In this way, comfort and a driving experience are further enhanced. Alternatively, the driving profile is specified by a manufacturer or lessor of the electric vehicle, for example. It is thus possible, for example, to charge the user differently depending on the respective driving profile.

For example, the first acceleration value is calculated using a formula. Particularly preferably, however, the first acceleration value is determined by means of a table. Thus, an effort is reduced and the table is, for example, created only once by the manufacturer of the main drive and used for all such main drives. In particular, the table is static. Alternatively, the table can also be modified, in particular as a function of the respective driving profile. Particularly preferably, several tables are available, whereby these are selected according to the respective possible driving profile. The tables are preferably stored in a common map, with the respective table being read out from the map as a function of the possible driving profile. For example, in the case of one of the driving profiles, a comparatively high first acceleration value is determined in the case of a low operation of the control element, whereas in the case of another table, in particular in the case of another driving profile, such a first acceleration value is assigned only to an extensive operation of the control element. Thus, a flexibility and also a driving experience is further increased.

For example, the current acceleration can be determined using a sensor, in particular an acceleration sensor. The acceleration sensor is, for example, a component of the main drive or at least of the electric vehicle and is signal-coupled to the main drive. For example, the sensor is also used for other tasks, which is why no additional hardware is required and therefore manufacturing costs are not increased.

Also, the current acceleration can be determined on the basis of a current velocity. In particular, a timing element is used for this purpose, and the current velocity is fed to a unit to create a difference once directly and once via the timing element. In this way, a comparatively simple determination of the current acceleration is possible. The current speed is measured, for example, by means of a sensor associated with a wheel of the electric vehicle. For example, the wheel is driven by means of the main drive. Alternatively, the wheel is not driven. In this way, for example, if the wheel driven by the main drive spins, it is still possible to determine the current acceleration comparatively accurately.

Preferably, the current acceleration can be determined on the basis of operating data of the main drive. In particular, the current speed is first determined on the basis of the operating data and from this the current acceleration. For this purpose, for example, the current speed is determined on the basis of an electrical voltage applied to the electric motor and/or an electrical current conducted by means of the electric motor. Particularly preferably, however, the electric motor is assigned a sensor by means of which the operating data are recorded. The sensor is in particular a hall sensor, by means of which the speed of the electric motor and thus the current speed of the electric motor can be measured, which is functionally related to the speed of the electric vehicle.

For example, a current position of the control element can be used as the setting of the control element. In other words, the position in which the control element is located and in which it is held by the user, for example, is checked, in particular against a spring force. Thus, an intuitive creation of the setting and thus implicitly also of the first acceleration value is made possible for the user. Alternatively or, in particular at times, in combination therewith, a rate of change of the position of the control element is detected and this is used as the setting of the control element. For example, a comparatively large first acceleration value is determined for a large rate of change and a comparatively small first acceleration value is determined for a small rate of change. Due to the use of the rate of change, for example in an emergency situation, a comparatively fast conversion of the desired acceleration is possible, provided that this does not exceed the maximum acceleration, so that safety is further increased.

The main drive can be a component of an electric vehicle, which is, for example, land-based, and which is, for example, a truck (lorry), bus or passenger car. Particularly preferably, the electric vehicle is of single-track design and is, for example, a motor scooter, motorcycle, e-bike or pedelec.

The main drive comprises an electric motor. The electric motor is, for example, a brushed commutator motor or, particularly preferably, a brushless motor. In particular, the electric motor is a brushless direct current (BLDC) motor. The electric motor preferably comprises several electric coils, which are expediently divided into several phases. Here, the same number of electric coils is expediently assigned to each phase. The phases are interconnected, for example, in a delta or star connection. Expediently, the main drive comprises a unit by means of which the current is supplied to the electric motor. This unit preferably comprises a converter, which in particular has a bridge circuit, such as in particular a B6-circuit. At least the number of bridge branches corresponds in particular to the number of phases of the electric motor. For example, the drive comprises a gearbox driven by means of the electric motor. The gearbox or the electric motor are in particular suitable, preferably provided and arranged, to be coupled to a wheel of the electric vehicle so that the wheel is driven by means of the electric motor either directly or indirectly via, for example, further components such as the gearbox.

The main drive has a control unit which is provided and arranged, preferably suitable, for carrying out a method for operating a main drive of an electric vehicle. In the method, a first acceleration value is determined on the basis of a setting of an operating element, and a second acceleration value is determined on the basis of a deviation of a current acceleration from a predetermined maximum acceleration. The minimum of the first acceleration value and the second acceleration value is selected as a control value. An energization (e.g., current supply) of the main drive (e.g., to the electric motor) is set in accordance with the control value.

The control unit comprises, for example, an application-specific circuit (ASIC) or, particularly preferably, a computer suitably designed to be programmable. In particular, the control unit comprises a storage medium on which a computer program product, also referred to as a computer program, is stored, wherein upon execution of this computer program product, i.e., the program, the computer is caused to perform the method.

For example, the control element is a component of the main drive or is separate from it. In this case, however, the control element is preferably signal-coupled to the main drive in the assembly state, and the main drive has a corresponding interface for this in particular. A first determination unit of the control unit is used in particular to determine the first acceleration value.

For example, the current acceleration is determined by means of the main drive itself, for which a corresponding sensor is used, which is in particular a component of the main drive. Alternatively, the main drive is signal-coupled (signal-technically coupled) to such a sensor in the assembly state, and the main drive has in particular a corresponding interface for this. Suitably, all existing possible interfaces are integrated into a common interface which, for example, satisfies a bus standard. Preferably, the control unit comprises a unit by means of which the maximum acceleration is specified. Expediently, the control unit comprises a second determination unit by means of which the second first acceleration value is determined. Preferably, the control unit comprises a third determination unit by means of which the selection of the control value is carried out, i.e., by means of which the minimum is determined from the two acceleration values.

Alternatively, or in combination, the control unit comprises a unit by means of which the setting of the current of the main drive is adjusted in accordance with the control value. For example, the control unit comprises a control or regulation of an electric current by means of which the electric motor is operated. For example, the main drive comprises the inverter, if any, by means of which the electric motor is energized, the adjustment of the inverter being performed by means of the control unit. For example, all of the units, that is, in particular, the determination units, which are used to carry out the method, are a component of the computer program or are constructed at least in part by means of discrete components. In other words, the units are, for example, provided by means of software routines or discretely constructed circuits.

In addition, the invention relates to an electric vehicle with such a main drive. In particular, the electric vehicle is a motor scooter or a motorcycle, wherein the propulsion is electric. Alternatively, the electric vehicle is, for example, a pedelec or an e-bike. The invention further relates in particular to such a control unit. The control unit is suitable, in particular arranged/provided, for carrying out the method.

The computer program product includes a plurality of instructions that, when the program (computer program product) is executed by a computer, cause the computer to perform a method for operating a main drive of an electric vehicle. In the method, a first acceleration value is determined based on a setting of an operating element. A second acceleration value is determined based on a deviation of a current acceleration from a predetermined maximum acceleration. The minimum of the first acceleration value and the second acceleration value is selected as a control value, and an energization/of the main drive is set in accordance with the control value.

The computer is expediently a component of a control unit and is formed, for example, by means thereof. The computer preferably comprises or is formed by means of a microprocessor. The computer program product is, for example, a file or a data carrier containing an executable program which, when installed on a computer, automatically executes the method.

The invention further relates to a storage medium on which the computer program product is stored. Such a storage medium is, for example, a CD-ROM, a DVD or a Blu-Ray disc. Alternatively, the storage medium is a USB flash drive or other memory that is, for example, rewritable or writable only once. Such a memory is, for example, a flash memory, a RAM or a ROM.

The further developments and advantages explained in connection with the method are also to be applied mutatis mutandis to the main drive/the electric vehicle/the control unit/the computer program product/the storage medium and to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematic of an electric vehicle with a main drive,

FIG. 2 shows a method of operating the main drive, and

FIG. 3 shows a section of the main drive schematically.

### DETAILED DESCRIPTION

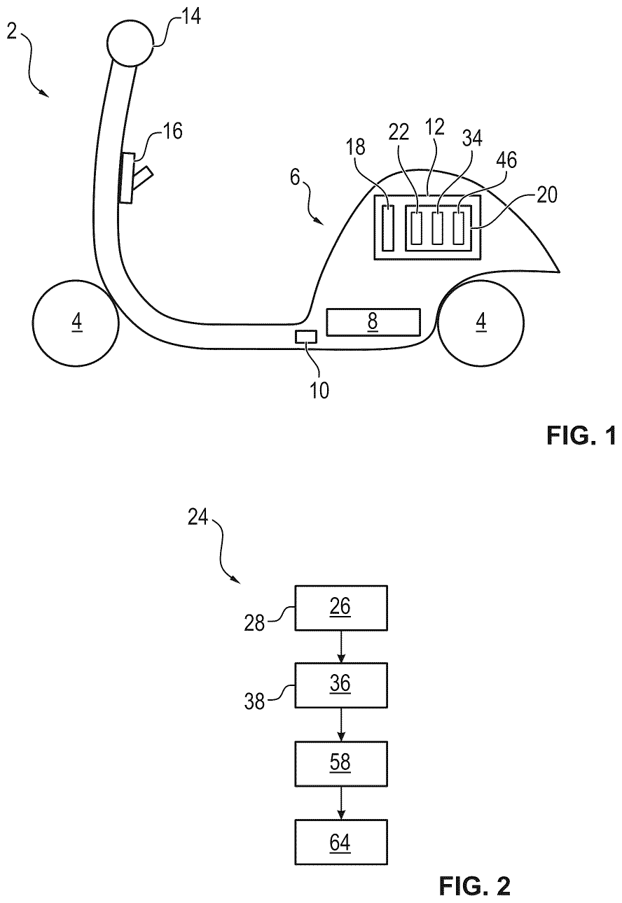

FIG. 1 shows a schematic simplification of an electric vehicle 2 in the form of a scooter. The electric vehicle 2 thus has two wheels 4, one of which is driven by means of a main drive 6. The main drive 6 comprises an electric motor 8, which is a brushless DC motor (BLDC). By means of the electric motor 8, a gearbox, which is in operative connection with one of the wheels 4. The electric motor 8 is operated by means of an on-board power supply, which is fed by means of a battery 10 providing an electrical DC voltage of 12 V.

The battery 10 is used to supply power to an inverter of the main drive 6, and comprises a bridge circuit. The inverter itself is adjusted by means of the control unit 12 so that the electric motor 8 is supplied with electric current in accordance with a specific specification. The electric vehicle 2 further comprises a control element 14 in the form of a rotatable handle, by means of which an unspecified user can change a setting of the main drive 6. In addition, the electric vehicle 2 comprises a selection lever 16 by means of which the electric vehicle 2 can be adjusted according to the user's preferences. In the example shown, the selection lever 16, the control element 14 and the battery 10 are not components of the drive 6, but are connected to it, namely in terms of signals and/or electrically.

The control unit (control device) 12 has a computer 18 in the form of a programmable microprocessor. In addition, the control unit 12 includes a storage medium 20 in the form of a memory on which a computer program product 22 is stored. The computer program product 22 includes a plurality of instructions which, when executed by the computer 18, cause the computer 18 to execute a method 24 shown in FIG. 2 for operating the main drive 6. In other words, the control unit 12 is provided and arranged to perform the method 24.

In a first step 26, a setting 28 of the control element 14 is detected. The setting 28 is thereby measured by means of a sensor of the operating element 14, and is transmitted to the main drive 6, namely the control unit 12, by means of the signal-technical coupling. The setting 28 is a current position of the control element 14, i.e., the position in which the rotary handle is held by the user against a spring load. In an alternative embodiment, or when the current position of the control element 14 is changed comparatively quickly, the rate of change of the position of the control element 14 is used as the setting 28. In summary, when the handle is rotated comparatively quickly, the rate of change is used as the setting 28, whereas the current position is used as the setting 28 when the rate of change is below a threshold value.

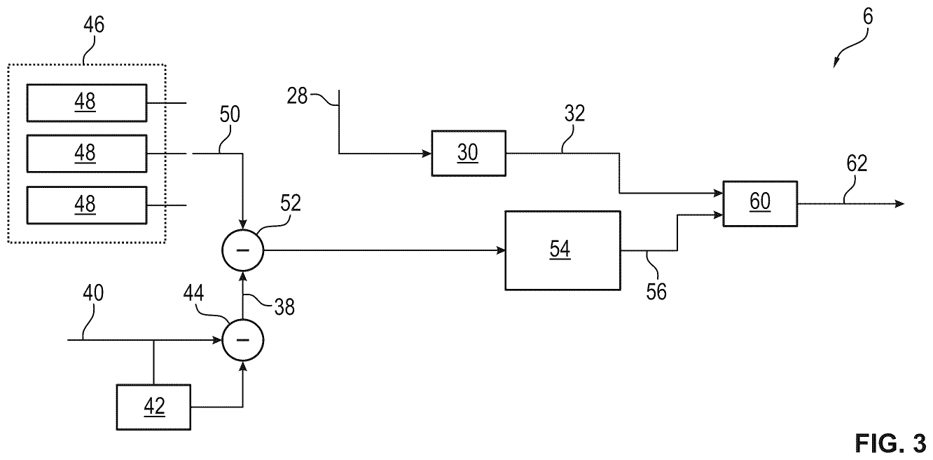

Based on the setting 28, a first acceleration value 32 is determined by means of a first determination unit 30 of the control unit 12, which is implemented by means of the software routines of the computer program product 20 and is thus a component of the control unit 12, as shown in FIG. 3 in a schematic representation of the main drive 6. For this purpose, the first determination unit 30 uses a table 34 stored in the memory 20, by means of which a different first acceleration value 32 is assigned to each of the possible different settings 28. In summary, the first acceleration value 32 is determined using the table 34. The first acceleration value 32 is here the value of a torque which is to be applied by means of the electric motor 8 so that the electric vehicle 2 reaches a certain speed.

In a second step 36, a current acceleration 38 of the electric vehicle 2 is determined. For this purpose, a current speed 40 is fed once directly and once via a timing element 42 to a first unit to create a difference 44, by means of which the two values are subtracted from each other. The current speed 40 is thereby determined by means of a speed sensor of the electric motor 8 and thus by means of the operating data of the main drive 6. Alternatively, the current speed 40 is determined on the basis of an electric current conducted by means of the electric motor 8, for example on the basis of artifacts present in the current (e.g., ripples).

In addition, during the second step 36 it is checked which of a plurality of driving profiles 48 stored in a driving profile memory 46 of the memory 20 has been selected. The driving profile 48 is selected by the user by means of the selection lever 16. A predetermined maximum acceleration 50 is associated with each of the driving profiles 48, and these differ between the individual driving profiles 48. In the second step 36, the predefined maximum acceleration 50 is read from the selected driving profile 48.

The predetermined maximum acceleration 50, which is dependent on the selected driving profile 48, and the current acceleration 48 are fed to a second unit to create a difference 52, by means of which the current acceleration 38 is subtracted from the maximum acceleration 50 and the deviation created in this way is fed to a second determination unit 54. By means of the second determination unit 54, a second acceleration value 56 is created from the deviation/difference. In summary, in the second step 36, the second acceleration value 56 is determined on the basis of the deviation of the current acceleration 38 from the predetermined maximum acceleration 50. For this purpose, by means of the second determination unit 54, the value of a torque corresponding thereto is determined from the value of the acceleration which was generated by means of the second unit to create a difference 52. This value of a torque is used as the second acceleration value 56. In summary, the value of a torque is thus used as the first and second acceleration value 32, 56 respectively.

In a third step 58, the minimum of the first acceleration value 32 and the second acceleration value 56 is determined by means of a third determination unit 60, and the minimum is used as a control value 62. In other words, the minimum of the first acceleration value 32 and the second acceleration value 56 is selected as the control value 62. The control value 62 thus corresponds to the value of the torque by which the torque currently applied by means of the electric motor 8 is to be changed. If the control element 14 has not been moved, the control value 62 thus corresponds to 0 Nm. If, on the other hand, the user of the control element 14 has turned it and an acceleration is to take place, i.e., the setting 28 has been changed, the control value 62 is greater than 0 Nm, whereby the control value 62 does not exceed the torque corresponding to the maximum acceleration 50 specified by means of the selected travel profile 48.

In a subsequent fourth step 64, an energization of the main drive 6, namely the electric motor 8, is set according to the control value 62. Preferably, the inverter is set accordingly for this purpose. In particular, an existing energization (e.g., current flow) is changed by the control value 62 so that, for example, an increased electric current is conducted by means of the electric motor 8. The increased current is dimensioned in particular in such a way that, in addition to the torque previously applied, a torque corresponding to the control value 62 is applied by means of the electric motor 8, so that the electric vehicle 2 is accelerated.

Thus, the acceleration of the electric vehicle 2 is independent of the course of the road along which the electric vehicle is moved, including the payload of the electric vehicle 2. Thus, it is possible to maintain a speed of the electric vehicle 2 even if the electric vehicle 2 is comparatively heavily loaded or moved along a comparatively steep track.

The invention is not limited to the embodiment described above. Rather, other variants of the invention can also be derived therefrom by the person skilled in the art without leaving the object of the invention. Furthermore, in particular, all individual features described in connection with the embodiment can also be combined with each other in other ways without leaving the object of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to operate a main drive of an electric vehicle, the method comprising:
determining a first acceleration value based on a setting of an operating element;
determining a second acceleration value based on a deviation of a current acceleration from a predetermined maximum acceleration;
selecting a minimum of the first acceleration value and selecting the second acceleration value as a control value; and
setting an energization of the main drive according to the control value.

2. The method according to claim 1, wherein a value of a torque is used as the first and second acceleration values.

3. The method according to claim 1, wherein the predetermined maximum acceleration is read out from a selected driving profile.

4. The method according to claim 1, wherein the first acceleration value is determined using a table.

5. The method according to claim 1, wherein the current acceleration is determined based on operating data of the main drive.

6. The method according to claim 1, wherein a current position of the operating element and/or a rate of change of the position of the operating element is used as the setting of the operating element.

7. A main drive of an electric vehicle, the main drive comprising:
an electric motor; and
a controller that is arranged to carry out the method according to claim 1.

8. A computer program product comprising instructions which, when the program is executed by a computer, cause the computer to execute the method of claim 1.
